(19) United States
(12) Patent Application Publication
(10) Pub. No.: US 2001/0011611 A1
(43) Pub. Date: Aug. 9, 2001

(54) CHASIS FOR COMMERCIAL VEHICLES

(76) Inventor: KLAUS-PETER POERSCHMANN, OBERREICHENBACH (DE)

Correspondence Address: KENYON & KENYON, ONE BROADWAY, NEW YORK, NY, 10004, US

(21) Appl. No.: 08/792,966

(22) Filed: Jan. 24, 1997

(30) Foreign Application Priority Data
Jan. 24, 1996 (DE) 296 01 177.0

(51) Int. Cl. B60K 1/00

(52) U.S. Cl. 180/65.1

(57) ABSTRACT

A chassis for commercial vehicles, comprises a rigid axle that is configured as a portal axle. A wheel is rotatably mounted at each end of the portal axle, and each wheel is driven by at least one electric wheel drive motor arranged substantially at a right angle to the portal axle. A gear drive is arranged in each case between the drive motor and the rim of the wheel. The housing of the drive motor and housing of the gear drive are joined nonpositively to one another, and the housings of the gear drives are mounted nonpositively to the portal axle.

### BACKGROUND OF THE INVENTION

The invention concerns a chassis for commercial vehicles. Commercial vehicles such as city buses are used for the conveyance of passengers. In such city buses, a low vehicle floor is required. In the door area, the vehicle floor height should be only 320 mm so that only one step needs to be climbed when boarding, or so that a level entry is possible at a ramp or a high curb. Ideally, the low vehicle floor should pass through the entire bus at this level, particularly in the area of the rear axle. For city buses driven by an internal combustion engine, it has not yet been possible to meet his requirement which has already been achieved in rail vehicles. Even when so-called “portal axles” are used, the transition over the rear axle cannot be completely lowered due to the propeller shaft that is required. Moreover the propeller shaft is maintenance-intensive as a mechanical part, and generates noise that is transmitted to the vehicle frame.

City buses are known with a diesel-electric drive in which the electric motors are arranged, as wheel motors, on the wheelset. In the case of the known chassis, rigid axles are used for wheel suspension for economic reasons. Although this arrangement produces a continuous low vehicle floor, the passageway between the wheel wells is only approx. 480 mm and is therefore relatively narrow.

German Patent 41 12 624 discloses a chassis for a commercial vehicle in which an electric motor is arranged eccentrically with respect to the drive shaft. The motor axis and wheelset axis are thus parallel, but not at the same height. With the motor designs presently available, only a relatively narrow passageway between the wheel wells can be achieved with this.

German Patent 24 25 960 describes an electrically driven wheelchair whose drive arrangement is not suitable for commercial vehicles since commercial vehicles travel more quickly and are considerably heavier.

Also known from German Patent Application 43 03 480 is a converter-powered asynchronous motor for driving motor vehicles; the arrangement of the motor in the motor vehicle is not disclosed.

U.S. Pat. No. 4,807,716 describes a manually controlled lift truck driven by electric motors for transporting goods over very short distances such as inside warehouses. Power transfer from both electric motors to the respective drive wheels is accomplished via a drive chain, and is thus not suitable for continuous and long-distance operation with large load cycles.

In addition, U.S. Pat. No. 1,481,408 describes a chassis for a motor vehicle which has a rigid axle that extends continuously at the height of the wheel hubs, and thus does not allow a low-floor design for the motor vehicle. Each of the two wheels arranged at the ends of the rigid axle is driven by an electric motor. The electric motors are mounted on the sprung mass of the chassis, and are each joined by a propeller shaft to the gear drive set of the respective drive wheel. In the case of the chassis according to U.S. Pat. No. 1,481,405, the propeller shaft is necessary to compensate for the changing drive angle resulting from spring deflection of the motor vehicle. Because the propeller shaft is needed, the electric motor cannot be installed in the vicinity of the axle.

German Patent 36 41 022 describes a wheel drive system that is suitable for stacker trucks. The direct-current motor, arranged near each wheel and eccentrically with respect to it, is coupled to the relevant wheel via a bevel gear drive stage. With the motor designs presently available, implementation of this drive concept leads to a relatively narrow passageway between the wheel wells.

German Examined Application 1 227 783 discloses a drive axle for electric vehicles. Each drive wheel is driven, via a planetary gear drive, by a direct-current motor arranged in the wheel hub. The arrangement of the electric motor in the wheel hub makes access difficult for maintenance work.

GB Patent Disclosure Document 2 102 360 describes an electrically driven axleless wheelchair. The electric motor is mounted by means of its gear drive housing onto the frame of the wheelchair. This drive arrangement is also not suitable for commercial vehicles which travel more quickly and are considerably heavier.

Moreover, U.S. Pat. No. 1,543,044 describes a chassis for a motor vehicle which has a rigid axle that extends continuously at the height of the wheel hubs and thus does not allow a low-floor design for the motor vehicle. Each of the two wheels arranged at the ends of the rigid axle is driven by an electric motor. The electric motors are mounted on the sprung mass of the chassis, and each joined by a toothed shaft to the gear drive set of the respective drive wheel. In the case of the chassis according to U.S. Pat. No. 1,543,044 the toothed shaft is necessary to compensate for the change in distance between wheel axle and motor shaft resulting from spring deflection of the motor vehicle. Because of the toothed shaft, the electric motor cannot be installed in the vicinity of the axle.

It is therefore the object of the present invention to create a chassis for a commercial vehicle that has a wide, low vehicle floor even in the vicinity of the rear axle, extending on the same level as the low-floor portion in the door area.

### SUMMARY OF THE INVENTION

This object is achieved by providing a chassis having a rigid axle that is configured as a portal axle. Rotatably mounted at each end of this portal axle is a wheel, each wheel being driven by an electric wheel drive motor arranged substantially at a right angle to the portal axle. A gear drive is arranged between the drive motor and the wheel rim. Furthermore the housing of the drive motor and the housing of the gear drive are in each case nonpositively joined to one another, and the housing of the gear drive is nonpositively mounted on the portal axle.

### BRIEF DESCRIPTION OF THE DRAWING

FIG. 1 is a schematic illustration of a chassis according to the present invention.

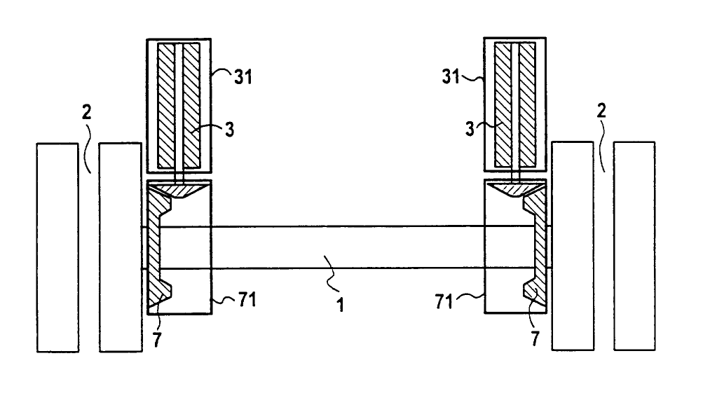

### DETAILED DESCRIPTION

The chassis depicted in the drawing comprises a portal axle 1 at each of whose ends a wheel 2 is rotatably mounted. In the exemplified embodiment depicted, wheels 2 are configured as wheelsets with dual tires.

The two wheels 2 are each driven by an electric drive motor 3. In the exemplified embodiment shown, drive motors 3, arranged substantially at a right angle to the portal axle, are arranged horizontally and therefore lie at substantially the same height as portal axle 1. The transition over portal axle 1 can thus be lowered to the level of the low-floor portion in the door area.

The electric drive motors 3 are configured as geared motors, contrate (crown) gear drives preferably being used as the gear drives since they are particularly well suited for gearing down small and therefore high-speed motors. Each drive motor is nonpositively joined by its housing 31 to housing 71 of its gear drive 7. In addition, housings 71 of both gear drives 7 are nonpositively mounted on portal axle 1.

In the case of the chassis according to the invention, the term “wheel” is understood to mean not only individual wheels but also wheelsets which have dual tires. The term “substantially at a right angle” is here intended also to comprise arrangements in which the angle between drive motor and portal axle is not exactly 90 degrees.

The arrangement of the electric drive motor 3 at an angle of approximately 90 degrees or exactly 90 degrees results, in the region between the wheel wells of the rear axle, in a relatively wide, low-floor portion that extends on the same level as the low-floor portion in the door area.

Because of the arrangement of the electric drive motors 3 at a right angle to the portal axle 1, the drive motors 3 are freely accessible, thus ensuring easy installation and no difficulty in replacing the drive motors 3. The installation spaces for the electric drive motors 3 are located near the portal axle 1. The drive motors 3 are preferably completely encapsulated and liquid-cooled. This makes then insensitive to contamination in this installation location near the wheel.

The chassis according to the invention can be used for all kinds of electrically driven commercial vehicles. These include commercial vehicles powered by an overhead conductor, a battery, an internal combustion engine with generator, a flywheel storage device, or a fuel cell. In all cases, the drive line is mechanically decoupled, which results in reduced noise. Moreover a diesel-electric drive system has lower fuel consumption and lower emissions compared to a diesel drive system, since the diesel drive system can be kept in the optimum rotation speed range, and rotation speed is regulated steplessly by means of the electric drive motor.

When the drive motors 3 are arranged vertically, they are particularly well protected from mechanical influences, since any impediments that may occur between the wheels 2 make contact only with the portal axle 1, regardless of the direction of travel.

In principle, any electric drive motor can be installed in the chassis according to the invention. It is particularly advantageous, however, to use a three-phase asynchronous unit with a cage rotor. Drive motors of this kind are of simple and robust construction and can be produced economically. Because of their sturdiness, three-phase asynchronous motors are particularly well suited for installation on the portal axle 1. Moreover the rotation speed of a three-phase asynchronous unit can be selected without restriction, and the ratio of diameter to length can be varied. The field of the three-phase asynchronous unit can be attenuated as desired, so that optimum torque and output characteristics can be achieved over the entire speed range. A transmission, which requires additional installation space, can thus be omitted.

What is claimed is:

1. A chassis for commercial vehicles, the chassis comprising:
a rigid axle configured as a portal axle;
two wheels, each wheel having a rim and being rotatably mounted at a respective end of the portal axle, wherein each of the wheels is driven by at least one electric wheel drive motor arranged substantially at a right angle to the portal axle, each of the at least one electric wheel drive motor having a housing; and
a plurality of gear drives, each gear drive having a housing, wherein one of the plurality of gear drives is arranged in each case between the drive motor and the rim of the wheel, wherein the housing of one of the drive motors and the housing of a corresponding gear drive are joined nonpositively to one another, and the housings of the gear drives are mounted nonpositively to the portal axle.

2. The chassis of claim 1, wherein the drive motor is arranged substantially at the same height as the portal axle.

3. The chassis of claim 1, wherein the drive motor is arranged vertically.

4. The chassis of claim 1, wherein the drive motor is configured as a three-phase asynchronous unit with cage rotor.
